(19) United States
(12) Patent Application Publication
(10) Pub. No.: US 2023/0151248 A1
(43) Pub. Date: May 18, 2023

(54) SUSTAINABLE REACTIVE HOT MELT ADHESIVE COMPOSITIONS

(71) Applicant: H.B. Fuller Company, St. Paul, MN (US)

(72) Inventor: Chao Wang, Woodbury, MN (US)

(21) Appl. No.: 18/056,065

(22) Filed: Nov. 16, 2022

Related U.S. Application Data
(60) Provisional application No. 63/264,110, filed on Nov. 16, 2021.

(51) Int. Cl. C09J 7/35; C09J 11/06; C09J 11/08; C09J 133/06

(52) U.S. Cl. CPC C09J 7/35; C09J 11/06; C09J 11/08; C09J 133/06; C09J 2203/326; C09J 2301/304; C09J 2301/312; C09J 2301/408

(57) ABSTRACT

The invention features a reactive hot melt adhesive composition comprising the reaction product of from 5% by weight to 40% by weight of a first polyester polyol comprising the reaction product of a dicarboxylic acid monomer, a tetra alkyl cyclobutane diol and optionally one or more additional monomers, from 10% by weight to 80% by weight of a sustainable polyol, and a diisocyanate.

### CROSS REFERENCE TO RELATED APPLICATIONS

This application claims the benefit of U.S. Provisional Application No. 63/264,110, filed Nov. 16, 2021, which is incorporated herein.

The invention is directed to sustainable reactive hot melt adhesive compositions.

Reactive hot melt adhesive compositions have been used in a wide variety of applications to form strong permanent bonds between various substrates.

Reactive hot melt adhesive compositions are commonly based on isocyanate terminated polyurethane prepolymers that react with surface or ambient moisture to chain-extend, forming a urethane-urea polymer. These polyurethane prepolymers are traditionally produced using petrol-based raw materials.

End users have begun to request reactive hot melt adhesive compositions with increased sustainable content. In addition to sustainable content, there is a desire for compositions that have superior initial strength and tensile properties and that are free of contaminants that can be found in aromatic diols e.g., bisphenol A.

### SUMMARY

In one aspect, the invention features a reactive hot melt adhesive composition including the reaction product of from 5% by weight to 40% by weight of a first polyester polyol including the reaction product of a dicarboxylic acid monomer, a tetra alkyl cyclobutane diol, and optionally one or more additional monomers, from 10% by weight to 80% by weight of a sustainable polyol, and a diisocyanate.

In one embodiment, the first polyester polyol has a Glass Transition Temperature of from 20° C. to 65° C. In another embodiment, the reactive hot melt adhesive composition has no greater than 10% by weight of an acrylic polymer or is even free of acrylic polymer.

In a different embodiment, the reactive hot melt adhesive composition has no greater than 10 % by weight of a polypropylene glycol. In another embodiment, the tetra alkyl cyclobutane diol is 2,2,4,4-tetramethylcyclobutane-1,3 diol.

In one embodiment, the reactive hot melt adhesive composition has a sustainable content of from 20% by weight to 100% by weight, or even from 40% by weight to 100% by weight. In a different embodiment, the reactive hot melt adhesive composition has a bio-based carbon content based on the total carbon content, according to ASTM 6866-20 of from 40% by weight to 100% by weight.

In one embodiment, the sustainable polyol is bio-based. In another embodiment, the sustainable polyol includes a bio-based polyether polyol and a bio-based polyester polyol. In a different embodiment, the sustainable polyol includes a bio-based polyether polyol, a bio-based crystalline polyester polyol, and a bio-based amorphous polyester polyol.

In one embodiment, the diisocyanate is selected from the group consisting of bio-mass balanced and bio-based. In another embodiment, the reactive hot melt adhesive composition further includes a thermoplastic polymer selected from the group consisting of polyesters and polyurethanes. In one embodiment, the thermoplastic polymer is sustainable.

In an embodiment, the reactive hot melt adhesive composition has a Brookfield Viscosity at 120° C. of no greater than 10,000 cP, a Brookfield Viscosity @ 110° C. of no greater than 10,000 cP or even a Brookfield Viscosity at 110° C. of from 100 cP to 5,000 cP.

In one embodiment, the reactive hot melt adhesive composition has a monomeric diisocyanate content of no greater than 0.5% by weight. In another embodiment, the reactive hot melt adhesive composition has one additional property selected from the group consisting of a Brookfield Viscosity of no greater than 10,000 cP at 110° C., and a monomeric diisocyanate content of no greater than 0.5% by weight.

In another aspect, the invention features a reactive hot melt adhesive composition including the reaction product of from 5% by weight to 40% by weight of a first polyester polyol including the reaction product of dicarboxylic acid monomer, a tetra alkyl cyclobutane diol, and optionally one or more additional monomers, from 20% by weight to 80% by weight of a sustainable polyol, and a diisocyanate, wherein the reactive hot melt adhesive composition has a sustainable content of from 40% by weight to 100% by weight.

In one embodiment, the reactive hot melt adhesive has a Brookfield Viscosity of no greater than 6,500 cP at 110° C. In another embodiment, the invention includes an article comprising two substrates bonded with the reactive hot melt adhesive of claim 1 wherein the two substrates are selected from the group consisting of wood, engineered wood, glass, metal, polyolefin, polyether sulfones, polycarbonate, polyamide, polyester, acrylic, acrylonitrile butadiene styrene, poly (methyl methacrylate), poly vinyl chloride, fiber reinforced versions thereof, surface treated versions thereof, and combinations thereof. In another embodiment, the invention includes an electronic component including the reactive hot melt adhesive composition.

The inventors have discovered reactive hot melt adhesive compositions that can include a significant amount of sustainable content and that further have superior initial strength and tensile properties. The reactive hot melt adhesive compositions can be free of or include only limited amounts of materials such as acrylic polymers and aromatic diols.

Acrylic polymers are often added to reactive hot melt adhesive compositions to improve initial strength and final cured properties. When acrylic polymers are used, it is often necessary to add a significant amount of polypropylene glycol to maintain compatibility. The addition of polypropylene glycol can have a negative effect on initial strength and final cured properties. Aromatic polyols can also be added to reactive hot melt adhesive compositions to improve strength and final cured properties. However, aromatic polyols are not as compatible with other preferred polyols, especially preferred bio-based polyols.

### DEFINITIONS

“Renewable” is used herein to refer to a resource that is produced by a natural process at a rate comparable to its rate of consumption. The resource can be replenished naturally or by engineered agricultural techniques. Examples of renewable resources include but are not limited to plants (e.g., sugar cane, sugar beets, corn, wheat, potatoes, citrus fruit (e.g. oranges), woody plants, cellulosic waste, etc.), animals, fish, bacteria, fungi, and forestry products (e.g. pine and spruce trees). These resources can be naturally occurring, hybrids, or genetically engineered organisms.

Natural resources such as crude oil, coal and natural gas are not considered renewable as they are derived from materials that will run out or will not be replenished for thousands or even millions of years.

“Bio-based” is used herein to refer to a material that is produced or is derived from at least 25% by weight of a renewable material.

“Recycled” is used herein to refer to a material that is produced or is derived from at least 25% by weight of a recycled material

“Sustainable” is used herein to refer to a material that is selected from the group consisting of bio-based and recycled.

“Bio-mass balanced” is used herein to refer to a material derived from both petrol-based and sustainable feed streams in which the sustainable portion has been allocated to the material.

Weight percent as used herein refers to the weight percent of the component in the reactive hot melt adhesive composition.

### DETAILED DESCRIPTION

### Reactive Hot Melt Adhesive Composition

The invention features a reactive hot melt adhesive composition comprising the reaction product of from 5% by weight to 40% by weight of a first polyester polyol comprising the reaction product of a dicarboxylic acid monomer, a tetra alkyl cyclobutane diol (TACD) and optionally one or more additional monomers, from 10% by weight to 80% by weight of a sustainable polyol, and a diisocyanate.

The invention further features a reactive hot melt adhesive composition comprising the reaction product of from 5% by weight to 40% by weight of a first polyester polyol comprising the reaction product of a dicarboxylic acid monomer, a tetra alkyl cyclobutane diol and optionally one or more additional monomers, from 20% by weight to 80% by weight of a sustainable polyol, and a diisocyanate, wherein the reactive hot melt adhesive composition has a sustainable content of from 40% by weight to 100% by weight.

The invention also features a reactive hot melt adhesive composition comprising the reaction product of from 5% by weight to 40% by weight of a first polyester polyol comprising the reaction product of a dicarboxylic acid monomer, a tetra alkyl cyclobutane diol and optionally one or more additional monomers, from 20% by weight to 80% by weight of a sustainable polyol, and a diisocyanate, wherein the reactive hot melt adhesive composition has a Brookfield Viscosity of no greater than 10,000 cP at 110° C.

The reactive hot melt adhesive composition can be free of or include limited amounts of acrylic polymers. The reactive hot melt adhesive composition can include no greater than 12% by weight, no greater than 10% by weight, no greater than 8% by weight, from 0% by weight to 12% by weight, or even from 2% by weight to 10% by weight of acrylic polymer.

The reactive hot melt adhesive compositions of this invention can exhibit desirable characteristics. The reactive hot melt adhesive composition can include a property selected from the group consisting of a Brookfield Viscosity of no greater than 10,000 cP at 110° C. and a monomeric diisocyanate content of no greater than 0.5% by weight.

The reactive hot melt adhesive composition can have a Sustainable Content of from 10% by weight, 20% by weight, 30% by weight, 40% by weight, 50% by weight, 60% by weight, 65% by weight, 70% by weight to 75% by weight, 80% by weight, 85% by weight, 90% by weight, 95% by weight, or 100% by weight, or a Sustainable Content between any pair of the foregoing values.

The reactive hot melt adhesive composition can have a bio-based carbon content, based on the total carbon content, according to ASTM 6866-20 of from 10% by weight, 20% by weight, 30% by weight, 40% by weight, 50% by weight, 60% by weight, 65% by weight, 70% by weight to 75% by weight, 80% by weight, 85% by weight, 90% by weight, 95% by weight, or 100% by weight, or a bio-based carbon content between any pair of the foregoing values.

The reactive hot melt adhesive composition can have a monomeric diisocyanate content of no greater than 10% by weight, no greater than 7.5% by weight, no greater than 5% by weight, no greater than 1% by weight, no greater than 0.5% by weight, from 0.0% by weight to 7.5% by weight, from 0.0% by weight to 5% by weight, or even less than 0.1% by weight, as tested according to the CURRENTA HPLC-MS/MS CAM-0642303-18E - FEICA Test Method.

The reactive hot melt adhesive composition is solid at room temperature. By solid it is meant that it is not a liquid.

The reactive hot melt adhesive composition can have a relatively low Brookfield Viscosity at a temperature of 120° C., or even at 110° C. The reactive hot melt adhesive composition can have a Brookfield Viscosity of no greater than 20,000 centipoise (cP), no greater than 15,000 cP, no greater than 10,000 cP, no greater than 6500 cP, from 100 cP to 15,000 cP, from 100 cP to 10,000 cP, from 250 cP to 10,000 cP, from 100 cP to 6500 cP, or even from 100 cP to 5,000 cP at 120° C.

The reactive hot melt adhesive composition can have a Brookfield Viscosity of no greater than 20,000 centipoise (cP), no greater than 15,000 cP, no greater than 10,000 cP, no greater than 6500 cP, from 100 cP to 15,000 cP, from 100 cP to 10,000 cP, from 250 cP to 10,000 cP, from 100 cP to 6500 cP, or even from 100 cP to 5,000 cP at 110° C.

The reactive hot melt adhesive composition can include a limited amount of petrol based polyol. The reactive hot melt adhesive composition can include no greater than 40% by weight, no greater than 35% by weight, from 5% by weight to 40% by weight, or even from 5% by weight of 30% by weight of a petrol based polyol.

### Polyurethane Prepolymer

The reactive hot melt adhesive composition includes one or more polyurethane prepolymers. The polyurethane prepolymer is generally isocyanate terminated. The polyurethane prepolymer includes the reaction product of a first polyester polyol including the reaction product of a dicarboxylic acid monomer, a tetra alkyl cyclobutane diol and optionally one or more additional monomers, a sustainable polyol and a diisocyanate.

### First Polyester Polyol

The first polyester polyol comprises the reaction product of a dicarboxylic acid monomer, a tetra alkyl cyclobutane diol, and optionally one or more additional monomers. The first polyester polyol can be petrol based. The first polyester polyol can help to improve the initial strength and the tensile properties of the reactive hot melt adhesive composition.

The first polyester polyol can have a Glass Transition Temperature (T_{g}) as tested by Differential Scanning Calorimetry (DSC) of from 20° C. to 65° C., 25° C. to 65° C., 30° C. to 60° C., or even from 35° C. to 55° C. A relatively high T_{g} is helpful to improve the initial strength and final tensile properties of the reactive hot melt adhesive composition.

The first polyester polyol includes those taught in WO2020/114489A1, which is hereby incorporated by reference.

The dicarboxylic acid monomer can be selected from the group consisting of isophthalic acid or esters thereof, terephthalic acid or esters thereof, phthalic acid or esters thereof, phthalic anhydride, 1, 4-cyclohexane-dicarboxylic acid, 1, 3-cyclohexanedicarboxylic acid, hexahydrophthalic anhydride, tetrahydrophthalic anhydride, dodecanedioic acid, sebacic acid, azelaic acid, maleic acid or anhydride, fumaric acid, succinic anhydride, succinic acid, adipic acid, dimer acid, hydrogenated dimer acid, 2, 6-naphthalenedicarboxylic acid, glutaric acid, itaconic acid, and combinations thereof.

The diol component can include a 2,2,4,4-tetraalkylcyclobutane-1,3-diol, a TACD which is a diol and can be represented by the general structure:

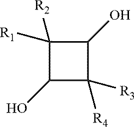

wherein R1, R2, R3, and R4 each independently represent an alkyl radical, for example, a lower alkyl radical having 1 to 8 carbon atoms, or 1 to 6 carbon atoms, or 1 to 5 carbon atoms, or 1 to 4 carbon atoms, or 1 to 3 carbon atoms, or 1 to 2 carbon atoms, or 1 carbon atom. The alkyl radicals may be linear, branched, or a combination of linear and branched alkyl radicals. Examples of TACDs include 2,2,4,4-tetramethylcyclobutane-1,3-diol (TMCD), 2,2,4,4-tetraethylcyclobutane-1,3-diol, 2,2,4,4-tetra-n-propylcyclobutane-1,3-diol, tetra-n-hexylcyclobutane-1,3-diol, 2,2,4,4-tetra-nheptylcyclobutane-1,3-diol, 2,2,4,4-tetra-n-octylcyclobutane-1,3-diol, 2,2-dimethyl-4,4-diethylcyclobutane-1,3-diol, 2-ethyl-2,4,4-trimethylcyclobutane1,3- diol, 2,4-dimethyl-2,4-diethyl-cyclobutane-1,3-diol, 2,4-dimethyl-2,4-di-npropylcyclobutane-1,3-diol, 2,4-n-dibutyl-2,4-diethylcyclobutane-1,3-diol, 2,4-dimethyl-2,4-diisobutylcyclobutane-1,3-diol, and 2,4-diethyl-2,4-diisoamylcyclobutane-1,3-diol.

Useful first polyester polyols include Eastman HM45 available from Eastman Chemical Company (Kingsport, TN) and having a Glass Transition Temperature (T_{g}) of about 42° C.

The reactive hot melt adhesive composition can comprise a reaction product including from 5% by weight to 40% by weight, from 5% by weight to 35% by weight, from 5% by weight to 30% by weight, from 5% by weight to 25% by weight, from 10% by weight to 35% by weight, from 10% by weight to 30% by weight, or even from 10% by weight to 25% by weight of the first polyester polyol

### Sustainable Polyol

The sustainable polyol can include one or more sustainable polyols. The sustainable polyol can be selected from the group consisting of a bio-based polyol and a recycled polyol.

The reactive hot melt adhesive composition can comprise a reaction product including from 10% by weight to 80%, from 15% by weight to 80% by weight, from 20% by weight to 80% by weight, from 30% by weight to 80% by weight, from 35% by weight to 80% by weight, from 40% by weight to 80% by weight, from 45% by weight to 80% by weight, from 50% by weight to 80% by weight, from 50% by weight to 75% by weight, or even from 55% by weight to 75% by weight of a sustainable polyol.

### Bio-Based Polyol

The sustainable polyol can include one or more bio-based polyols. The sustainable polyol can include only bio-based polyol. The bio-based polyol can include both an amorphous polyol and a crystalline polyol. In one embodiment, the bio-based polyol includes a crystalline polyester polyol. In another embodiment, the bio-based polyol can include an amorphous polyester polyol and a crystalline polyester polyol. The amorphous polyol can be liquid or solid. The crystalline polyol is typically a solid.

The bio-based polyol can be derived from e.g., soybean, millet, nuts (e.g., cashew nuts, etc.), corn, potatoes, citrus fruit (e.g., oranges), woody plants, cellulosic waste, etc., animals, fish, bacteria, fungi, forestry products (e.g., pine and spruce trees, tall oil, castor oil, sugar (sugar beets, sugar cane, etc.), wheat, or any other renewable material.

The bio-based polyol is produced or is derived from at least 25% by weight, at least 30% by weight, at least 50% by weight, at least 60% by weight, at least 70% by weight, at least 80% by weight, at least 90% by weight, from 25% by weight to 100% by weight, from 50% by weight to 100% by weight, from 70% by weight to 100% by weight, from 90% by weight to 100% by weight, or even 100% by weight of a renewable material.

The bio-based polyol can have bio-based carbon content according to ASTM 6866-20 of at least 25%, at least 30%, at least 50%, at least 60%, at least 70%, at least 80%, at least 90%, from 25% to 100%, from 50% to 100%, from 70% to 100%, from 90% to 100%, or even 100% based on the total carbon content.

Useful bio-based polyols include polyols available under the BIO-HOOPOL designation from Synthesia Technology (Barcelona, Spain) including BIO-HOOPOL 11034 (an amorphous liquid polyester polyol with a Bio-based Carbon content = 64.2% by ASTM 6866-20), BIO-HOOPOL 11003 (a crystalline solid polyester polyol with a Bio-based Carbon content = 100% by ASTM 6866-20), BIO-HOOPOL 11532 (Bio-based Carbon content = 100% by ASTM 6866-20), BIO-HOOPOL 11503 (Bio-based Carbon content = 100% by ASTM 6866-20), and BIO-HOOPOL 12930 (Bio-based Carbon content = 59.2% by ASTM 6866-20), under the DYNACOLL TERRA designation from Evonik Gmbh (Germany) including DYNACOLL TERRA EP 481.01, a crystalline solid polyester, made from 100% renewable resources available from Evonik Gmbh (Germany), liquid polyether polyols, made from 100% renewable resources available under the VELVETOL designation from Allessa GmbH (Frankfurt, Germany) including VELVETOL H-1000 AND VELVETOL H-2000 and polyester polyols available under the CHANDA trade designation from Chanda Chemical Corp. (Changhua, Taiwan) including CHANDA CA-4030SX (65.6% bio-based) and CB-4030SASZX (100% bio-based), polyols available from Panolam Industries International, Inc. including PIOTHANE 3500 H-SA (42% bio-based) and 3000 PDO-SBA (100% bio-based) and polyols available from Croda International PLC including PRIPLAST 3238 (100% bio-based) and PRIPLAST 3294 (100% bio-based).

The reactive hot melt adhesive composition can comprise a reaction product including from 10% by weight to 80%, from 15% by weight to 80% by weight, from 20% by weight to 80% by weight, from 30% by weight to 80% by weight, from 35% by weight to 80% by weight, from 40% by weight to 80% by weight, from 45% by weight to 80% by weight, from 50% by weight to 80% by weight, from 50% by weight to 75% by weight, or even from 55% by weight to 75% by weight of a bio-based polyol.

### Recycled Polyol

The recycled polyol is a polyol derived from recycled materials. The recycled polyol can include more than one recycled polyol. The recycled polyol can be an amorphous solid. The recycled polyol can improve the strength of the reactive hot melt adhesive composition.

The recycled polyol can be derived from recycled polycarbonate, recycled polyethylene terephthalate (PET), or any other recycled material.

Recycled polycarbonate can come from scrap polycarbonate recovered from containers, compact discs, construction materials, eyeglasses, consumer electronics or other sources.

Recycled PET can come from a variety of waste sources. The most common is the post-consumer waste stream of PET from plastic bottles or other containers.

The recycled polyol is derived from at least 25% by weight of a recycled material, but can be preferably derived from at least 30% by weight, at least 35% by weight, at least 60% by weight, at least 70% by weight, at least 80% by weight, at least 90% by weight, from 25% by weight to 100% by weight, from 35% by weight to 100% by weight, from 50% by weight to 100% by weight, from 75% by weight to 100% by weight or even 100% by weight of a recycled material.

Useful recycled polyols include polyols available under the HOOPOL designation including HOOPOL F-39037 (38% by weight Post-Consumer Recycled PET by ISO 14021:2016) available from Synthesia Technology (Barcelona, Spain).

### Diisocyanate

The diisocyanate can be liquid or solid at room temperature. The diisocyanate can be based on renewable materials, such as a bio-based difurfuryl diisocyanate, bio-based dimeryl diisocyanate, bio-based diphenyl methylene diisocyante or other renewable diisocyanate. Diisocyanates that are considered sustainable by bio-mass balance methods can also be used. The diisocyanate can be a blend of more than one diisocyanate.

Additional useful diisocyanates include, e.g., monomeric diisocyanates and oligomeric diisocyanates. The diisocyanate can be any suitable diisocyanate including, e.g., monomeric diisocyanates, oligomeric diisocyanates, aromatic diisocyanates, aliphatic diisocyanates, clycloaliphatic diisocyanates, and combinations thereof. Useful aromatic diisocyanates include, e.g., diphenyl methylene diisocyanate (MDI), (e.g., diphenylmethane-2,4′-diisocyanate (i.e., 2,4′-MDI), diphenylmethane-2,2′-diisocyanate (i.e., 2,2′-MDI), diphenylmethane-4,4′-diisocyanate (i.e., 4,4′-MDI), and combinations thereof), tetramethylxylene diisocyanate, naphthalene diisocyanate (e.g., naphthalene-1,5-diisocyanate, naphthalene-1,4-diisocyanate, and combinations thereof), toluene diisocyanate (TDI) (e.g., 2,4-TDI, 2,6-TDI, and combinations thereof), and combinations thereof. Useful cycloaliphatic diisocyanates include, e.g., 1-isocyanatomethyl-3-isocyanato-1,5,5-trimethylcyclohexane (i.e., isophorone diisocyanate (i.e., IPDI)), 1-methyl-2,4-diisocyanato-cyclohexane, 1,4-diisocyanato-2,2,6-trimethylcyclohexane (i.e., TMCDI), hydrogenation products of the aforementioned aromatic diisocyanates (e.g., hydrogenated 2,4′-MDI, hydrogenated 2,2′-MDI, hydrogenated 4,4′-MDI and combinations thereof), and combinations thereof. Useful aliphatic diisocyanates include, e.g., hexamethylene diisocyanate (HDI) (e.g., 1,6-diisocyanato-2,2,4-trimethylhexane, 1,6-diisocyanato-2,4,4-trimethylhexane diisocyanate, and combinations thereof), lysine diisocyanate, dodecane diisocyanate and combinations thereof.

Preferably the diisocyanate is monomeric isocyanate. Useful diisocyanate monomers are commercially available under a variety of trade designations including, e.g., under the DESMODUR and MODUR series of trade designations from Covestro LLC (Pittsburgh, Pennsylvania) including, e.g., MODUR M, 4,4′-MDI, LUPRANATE M, 4,4′-MDI from BASF Corp. (Wyandotte, Michigan), RUBINATE 44 from Huntsman Corp. (Auburn Hills, Michigan), ONGRONAT 3000, a 4,4-MDI available from Wanhua Chemical Group (Yantai, China), ISONATE M 125 from The Dow Chemical Company (Midland, Michigan), DDI 1410, a dimeryl diisocyanate, from BASF Corp. (Wyandotte, Michigan),

The reactive hot melt adhesive composition can comprise a reaction product including from 5% by weight to 35% by weight, from 10% by weight to 30% by weight, or even from 10% by weight to 20% by weight diisocyanate.

### Catalyst

The reactive hot melt adhesive composition optionally includes a catalyst to increase the cure reaction rate. Useful catalysts include ether and morpholine functional groups, examples of which include di (2,6-dimethyl morpholinoethyl) ether and 4,4′-(oxydi-2,1-ethanediyl) bis-morpholine (DMDEE). Suitable commercially available catalysts include, e.g., JEFFCAT DMDEE 4,4′-(oxydi-2,1-ethanediyl) bis-morpholine, which is available from Huntsman Corp. (Houston, Texas). Other suitable catalysts include, e.g., metallic carboxylates and dibutyl tin dilaurate. Useful metallic carboxylates include, e.g., cobalt carboxylates, manganese carboxylates, and mixtures thereof.

When a catalyst is present, the reactive hot melt adhesive composition includes from about 0.01 % by weight to about 0.5 % by weight catalyst.

### Thermoplastic Polymer

The reactive hot melt adhesive compositions of this invention can optionally include a thermoplastic polymer different from an acrylic polymer. The thermoplastic polymer includes thermoplastic polymers with a limited OH value, such as e.g., an OH value of < 10, or even < 5.

The thermoplastic polymer can be selected from the group consisting of polyesters (e.g., caprolactone) and thermoplastic polyurethanes. The thermoplastic polymer can be bio-based. Thermoplastic polymers considered sustainable by bio-mass balance methods can also be used

Useful thermoplastic polymers include those sold under the CAPA trade designation including CAPA 6400 and CAPA 6500 available from Ingevity (Brussels, Belgium) and those sold under the PEARLBOND trade designation including PEARLBOND DIPP 539 and PEARLBOND ECO 590 available from The Lubrizol Corp. (Wickliffe, Ohio).

The thermoplastic polymers can be present in the reactive hot melt adhesive composition at from 3% by weight to 20% by weight, at from 4% by weight to 15% by weight, from 3% by weight to 12% by weight, or even from 3% by weight to 10% by weight.

### Additional Components

The reactive hot melt adhesive composition optionally includes a variety of additional components including, e.g., antioxidants, stabilizers, additional polymers, tackifying agents, isocyanate trimers (e.g. DESMODUR N3300, an HDI-trimer, DESMODUR ECO N7300, a bio-based PDI-trimer available from Covestro LLC (Pittsburgh, Pennsylvania)), adhesion promoters, ultraviolet light stabilizers, UV brighteners, rheology modifiers, corrosion inhibitors, colorants (e.g., pigments and dyes), fillers, nucleating agents, and combinations thereof.

Likewise, the polyurethane prepolymer can optionally be derived in part from additional polyols including those considered sustainable by bio-mass balance methods and petrol-based polyols, e.g., polyester polyols e.g., crystalline polyester polyols, polyether polyols, and combinations thereof. Useful petrol-based polyols include those sold under the DYNACOL trade designation, including DYNACOL 7130, an amorphous polyester polyol available from Evonik Gmbh (Germany), those sold under the PIOTHANE trade designation, including PIOTHANE 3500 EAT, a liquid polyester polyol and PIOTHANE 3500 HA, a crystalline polyester polyol both available from Specialty Resins (Auburn, ME) and those sold under the VORANOL trade designation, including VORANOL CP 755, a polyether triol, available from The Dow Chemical Company (Midland, Michigan).

Useful antioxidants include, e.g., pentaerythritol tetrakis[3,(3,5-di-tert-butyl-4-hydroxyphenyl)propionate], 2,2′-methylene bis(4-methyl-6-tert-butylphenol), phosphites including, e.g., tris-(p-nonylphenyl)-phosphite (TNPP) and bis(2,4-di-tert-butylphenyl)4,4′-diphenylene-diphosphonite, di-stearyl-3,3′-thiodipropionate (DSTDP), and combinations thereof. Useful antioxidants are commercially available under a variety of trade designations including, e.g., the IRGANOX series of trade designations including, e.g., IRGANOX 1010, IRGANOX 565, and IRGANOX 1076 hindered phenolic antioxidants, and IRGAFOS 168 phosphite antioxidant, all of which are available from BASF Corporation (Florham Park, New Jersey), and ETHYL 702 4,4′-methylene bis(2,6-di-tert-butylphenol), which is available from Albemarle Corporation (Baton Rouge, Louisiana). When present, the reactive hot melt adhesive composition includes from 0% by weight to 3% by weight, or even from 0.1% by weight to 2% by weight antioxidant.

### Uses

The reactive hot melt adhesive compositions of this invention can be employed to bond a wide variety of substrates including fabric, glass (e.g. ink glass, uncoated glass, coated glass, etc.), metal (e.g. aluminum, anodized aluminum, stainless steel, etc.), polyolefins (e.g., polypropylene, polyethylene (e.g. low density polyethylene, linear low density polyethylene, high density polyethylene, etc.), polypropylene, oriented polypropylene, copolymers of polyolefins, etc.), surface treated (e.g. plasma treated, corona treated, etc.) polyolefins, metalized polyolefins (e.g. metalized polypropylene), polyether sulfones, polycarbonate, polyamide (e.g. nylon), polyester (e.g. polybutylene terephthalate (PBT), etc.), acrylics, acrylonitrile butadiene styrene (ABS), poly (methyl methacrylate) (PMMA), polyvinyl chloride (PVC), films of any kind, wood, engineered wood products, surface treated versions thereof and fiber reinforced (e.g. glass, natural fiber, carbon fiber, etc.) versions thereof.

The reactive hot melt adhesive compositions of this invention can be employed in all uses commonly known for reactive hot melt adhesives including adhering and/or sealing components of vehicles (e.g., automobiles, recreational vehicles, buses, trains, planes, etc.), windows, appliances, filters, electronic components, wood or plastic materials (e.g., laminated panels, edge-banding, profile wrapping, etc.), textiles, flooring etc.

The reactive hot melt adhesive compositions of this invention are useful for adhering and/or sealing electronic components for various applications including display bonding (e.g. phones, televisions, computers, tablets, e-readers, auto electronics, etc.), components of portable devices (e.g., smartphones, tablets, laptops, e-readers), components of wearable devices (e.g., smartwatch, earbuds, smartglass, virtual reality headset, etc.), accessory assembly (e.g., charger, finger print and touch sensor, et al.), battery assembly, and soft goods assembly (e.g. electronic cases and accessories).

The reactive hot melt adhesive composition may be applied to the substrate using any suitable coating process including, e.g., air knife, trailing blade, spraying, foaming, brushing, dipping, doctor blade, roll coating, gravure coating, offset gravure coating, rotogravure coating, linear extruder, pneumatic dispensing, jet dispensing, handgun and combinations thereof. The reactive hot melt adhesive can be printed on in a predetermined pattern. The reactive hot melt adhesive can be applied to a release liner where the adhesive/liner composite is adhered to a substrate.

The relatively low Brookfield viscosity of the reactive hot melt adhesive compositions of this invention enables them to be well suited for pneumatic dispensing and jet dispensing, and in particular for the assembly of electronic components.

The reactive hot melt adhesive composition can be applied at any suitable temperature including, e.g., from 80° C. to 170° C., from 80° C. to 160° C., from 80° C. to 120° C., or even from 100° C. to 120° C.

The surface of the substrate, on which the reactive hot melt adhesive composition is applied, optionally is treated to enhance adhesion using any suitable method for enhancing adhesion to the substrate surface including, e.g., corona treatments, chemical treatments, flame treatments, plasma treatments and combinations thereof.

### EXAMPLES

The reactive hot melt adhesive compositions were prepared by combining the components set forth in Table 1 except the diisocyanate, in the amounts set forth in Table 1. The mixture was then heated to 110° C. until all the components were melted. A vacuum was then applied and mixing was started and mixing was continued for one hour under vacuum. After one hour, the vacuum was released with nitrogen and the diisocyanate monomer was added to the mixture. The mixture was allowed to react for one hour while the temperature was maintained below 125° C. under vacuum with mixing.

### Test Procedures

The procedures were conducted at room temperature (i.e., an ambient temperature of from about 20° C. to about 25° C.) unless otherwise specified.

### Brookfield Viscosity Test Method

Brookfield Viscosity was measured on a molten sample that is at the stated temperature using a Brookfield Thermosel Viscometer with a number 27 spindle at 20 rotations per minute.

### Sustainable Content

For example, the Sustainable Content of Example 1 is:

$$21 \left(1\right) + 25.5 \left(.656\right) + 20 \left(1\right) = 57.7 \% \text{by weight}$$

The sustainable content in percent by weight is determined by multiplying the proportion of each sustainable component that is sustainable by the percentage of that component present in the reactive hot melt composition and adding the amounts together. The proportion of each sustainable component that is sustainable is the value reported by the supplier or alternatively, for bio-based components, it can be determined by ASTM 6866-20.

### Lap Shears

Lap shears were run according to ASTM D1002.

The substrates were plaques of clear Pelram polycarbonate (25.4 mm wide × 101.6 mm long × 4.8 mm thick). The adhesive was dispensed using a high precision adhesive dispensing robot under the following conditions: 23 gage needle, a syringe temperature of 140° C. and a needle temperature of 105° C.

The reactive hot melt adhesive composition was dispensed to cover a bond area of 12.7 mm × 25.4 mm × 0.15 mm thick - once the two substrates were pushed together. After application, the second plaque was pushed into place to cover the adhesive, forming a 12.7 mm overlap bond. A 7-kg weight was then placed on top of the bond for 1 minute, after which a 1-kg weight was placed on top of the bond for 5 minutes. All bonds were then aged at 25° C. & 50% relative humidity (RH) for the stated amount of time prior to testing.

### Tensile Properties

A film is prepared by forming the composition to be tested into a 0.508 millimeters (mm) (20 mil) thick film on release paper. The film is allowed to cure for seven days at 25° C. and 50 % relative humidity. Type IV dogbone samples are cut from the film. The ultimate stress, elongation at break, and Young’s modulus of the dried samples are then measured using an Instron testing machine at a cross heat speed of 10 centimeters (cm)/minute). The result is an average of 5 samples.

TABLE ONE

| | C1 | Ex 1 | Ex 2 | Ex 3 | Ex 4 |
|---|---|---|---|---|---|
| VORANOL 220-056N | 22.5 | | | | |
| VELVETOL H2000 (100% bio-based content) | | 21 | 21 | 21 | 21 |
| STEPANPOL PDP 70 | 10 | | | | |
| PIOTHANE 3500HA | 22.5 | | | | |
| CHANDA CA-4030SX (65.6% bio-based content) | | 25.5 | | | |
| DYNACOLL TERRA 481.01 (100% bio-based content) | | | | 21.2 | 16.5 |
| BIO-HOOPOL 12930 (59.2% bio-based content) | | | 25.9 | | |
| BIO-HOOPOL 11532 (100% bio-based content) | | | | | |
| PIOTHANE 2000 NA | 15 | | | | |
| PRIPLAST 3238 (100% bio-based content) | | 20 | 20 | 20 | 20 |
| DIANAL BR-113 | 12.5 | | | | |
| EASTMAN HM45 | | 15 | 15 | 15 | 15 |
| PEARLBOND ECO 590 (67% bio-based content) | | | | 5 | 10 |
| LUPRANARE M | 17 | 18 | 17.6 | 17.3 | 17 |
| DMDEE | 0.25 | 0.25 | 0.25 | 0.25 | 0.25 |
| SILQUEST A-189 | 0.25 | 0.25 | 0.25 | 0.25 | 0.25 |
| Brookfield Viscosity @ 110° C. (cP) | 2,375 | 2,300 | 2,450 | 4,900 | 8,600 |
| Sustainable Content (Weight %) | 0 | 57.7 | 56.3 | 65.6 | 64.2 |
| Lap shear - 1 hour (mPa, PC/PC) | 1.1 | 1.3 | 1.5 | 1.1 | 1.05 |
| Lap shear - 2 hours (mPa, PC/PC) | 2.1 | 2.3 | 2.8 | 1.8 | 1.7 |
| Lap shear - 72 hours (mPa, PC/PC) | 7.5 | 6.7 | 7.6 | 8.1 | 7.8 |
| Ultimate stress (mPa) | 10.3 | 12.3 | 12.0 | 8.2 | 7.8 |
| Elongation at break (%) | 1,075 | 1,065 | 1,065 | 978.6 | 924.2 |
| Young’s modulus (mPa) | 86 | 114 | 117 | 120 | 92.5 |

Other embodiments are within the claims.

What is claimed is:

1. A reactive hot melt adhesive composition comprising the reaction product of:
a. from 5% by weight to 40% by weight of a first polyester polyol comprising the reaction product of:
i. a dicarboxylic acid monomer,
ii. a tetra alkyl cyclobutane diol, and
iii. optionally one or more additional monomers,
b. from 10% by weight to 80% by weight of a sustainable polyol, and
c. a diisocyanate.

2. The reactive hot melt adhesive composition of claim 1 wherein the first polyester polyol has a Glass Transition Temperature of from 20° C. to 65° C.

3. The reactive hot melt adhesive composition of claim 1 having no greater than 10% by weight of an acrylic polymer.

4. The reactive hot melt adhesive composition of claim 1 having no greater than 10 % by weight of a polypropylene glycol.

5. The reactive hot melt adhesive composition of claim 1 wherein the tetra alkyl cyclobutane diol is 2,2,4,4-tetramethylcyclobutane-1,3 diol.

6. The reactive hot melt adhesive composition of claim 1 having a sustainable content of from 40% by weight to 100% by weight.

7. The reactive hot melt adhesive composition of claim 1 having a bio-based carbon content based on the total carbon content, according to ASTM 6866-20 of from 40% by weight to 100% by weight.

8. The reactive hot melt adhesive composition of claim 1 wherein the sustainable polyol is bio-based.

9. The reactive hot melt adhesive composition of claim 1 wherein the sustainable polyol comprises a bio-based polyether polyol and a bio-based polyester polyol.

10. The reactive hot melt adhesive composition of claim 1 wherein the sustainable polyol comprises a bio-based polyether polyol, a bio-based crystalline polyester polyol, and a bio-based amorphous polyester polyol.

11. The reactive hot melt adhesive composition of claim 1 wherein the diisocyanate is selected from the group consisting of bio-based and bio-mass balanced.

12. The reactive hot melt adhesive composition of claim 1 further comprising a thermoplastic polymer selected from the group consisting of polyesters and polyurethanes.

13. The reactive hot melt adhesive composition of claim 12 wherein the thermoplastic polymer is sustainable.

14. The reactive hot melt adhesive composition of claim 1 having a Brookfield Viscosity at 120° C. of no greater than 10,000 cP.

15. The reactive hot melt adhesive composition of claim 1 having a Brookfield Viscosity at 110° C. of from 100 cP to 5,000 cP.

16. The reactive hot melt adhesive composition of claim 1 having one additional property selected from the group consisting of:
a Brookfield Viscosity of no greater than 10,000 cP at 110° C., and
a monomeric diisocyanate content of no greater than 0.5% by weight.

17. A reactive hot melt adhesive composition comprising the reaction product of:
a. from 5% by weight to 40% by weight of a first polyester polyol comprising the reaction product of:
i. dicarboxylic acid monomer,
ii. a tetra alkyl cyclobutane diol, and
iii. optionally one or more additional monomers,
b. from 20% by weight to 80% by weight of a sustainable polyol, and
c. a diisocyanate,
wherein the reactive hot melt adhesive composition has a sustainable content of from 40% by weight to 100% by weight.

18. The reactive hot melt adhesives composition of claim 17 having a Brookfield Viscosity of no greater than 10,000 cP at 110° C.

19. An article comprising two substrates bonded with the reactive hot melt adhesive of claim 1 wherein the two substrates are selected from the group consisting of wood, engineered wood, glass, metal, polyolefin, polyether sulfones, polycarbonate, polyamide, polyester, acrylic, acrylonitrile butadiene styrene, poly (methyl methacrylate), poly vinyl chloride, fiber reinforced versions thereof, surface treated versions thereof, and combinations thereof.

20. An electronic component comprising the composition of claim 1.
